(19) United States
(12) Patent Application Publication
(10) Pub. No.: US 2006/0170614 A1
(43) Pub. Date: Aug. 3, 2006

(54) Large-scale display device

(76) Inventors: Ruey-Yau Tzong, Hsinchu (TW); Shein-Chi Lin, Hsinchu (TW); Heng Hsiang Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/046,811

(22) Filed: Feb. 1, 2005

(51) Int. Cl. G09G 5/00

(52) U.S. Cl. 345/1.3

(57) ABSTRACT

A large-scale display device has a plurality of display units, a plurality of screens and a plurality of adhesive bands. The plurality of display units is arranged in a matrix, and Frensnel lens screen(s) and diffuser screen(s) are correspondingly overlaid on the display units. The adhesive bands are used to affix the screens to the plurality of display units, or affix the plurality of Fresnel lens screens to the plurality of display units, followed by disposing a large-area diffuser screen on the previous screens. The sizes of the gaps between adjacent display units and the dark stripe in the large-scale image are thus reduced, such that the aesthetic feeling of the large-scale image is enhanced.

### BACKGROUND OF THE INVENTION

1. Field of the Invention

This invention refers to a large-scale display device, and more particularly to using adhesive bands to keep display screens attached to display units.

2. Description of the Related Art

In a conventional large-scale display device, multiple display screens are joined and aligned together in a matrix to make a large-scale display image, such as a conventional videowall. Such a large-scale display device can be used to present a complete large image, or simultaneously present many of the same or different images. To do this, a video-processing unit processes and delivers the image(s) to individual displays.

Referring to FIGS. 1 to 3, two adjacent displays 20a of a conventional large-scale display device 10a is shown, in which an individual display 20a includes a display unit 21a, a screen 25a and two brackets 30a. The screen 25a is mounted on one side of the display unit for displaying. The L-shaped bracket 30a is used to fix the screen 25a to the display unit 21a, and has a long side portion and a short side portion such that the front margin of the screen 25a is retained against the short side portion of the L-shaped bracket 30a, and the long side portion of L-shaped bracket 30a is locked and fixed to the side of the display unit 21a. In this way, both sides of a screen 25a are retained against two L-shaped brackets 30a, respectively, while both of the L-shaped bracket 30a are mounted to the side walls of the display units, respectively, so as to fix the screen 25a to the display unit 21a.

However, there are still disadvantages in a conventional large-scale display device. For example, in the case where multiple display screens are joined and aligned together in a matrix to constitute a large-scale display device, the two short rims obstruct the adaptation of the displayed images due to the addition of the sizes of the short rims of the adjacent L-shaped brackets (2-3 mm), and product dark stripes in the large-scale image, thus spoiling the aesthetic feeling of the large-scale image and partly blocking the projecting light in the case of a rear-projection TV (as shown in FIG. 3).

Accordingly, there is a need to improve the above inconvenience and disadvantage of the conventional large-scale display device in the actual application.

### SUMMARY OF THE INVENTION

It is one of the objects of this invention to provide a large-scale display device, in which a plurality of adhesive bands are affixed to both the screens and the display units, so as to keep the plurality of screens attached to the display units, thus reducing the gaps between two adjacent displays and the dark stripes in the large-scale image.

According to the previously-mentioned object of this invention, this invention is directed to a large-scale display device, which comprises a plurality of display units arranged in matrix form and a plurality of screens disposed on the display side of the display units correspondingly, and it is characterized by comprising a plurality of adhesive bands for affixing the plurality of screens to the display units, so as to keep the plurality of screens attached to the display units, thus reducing the sizes of the gaps between two adjacent displays and the dark stripes in the large-scale image.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of a conventional large-scale display device;

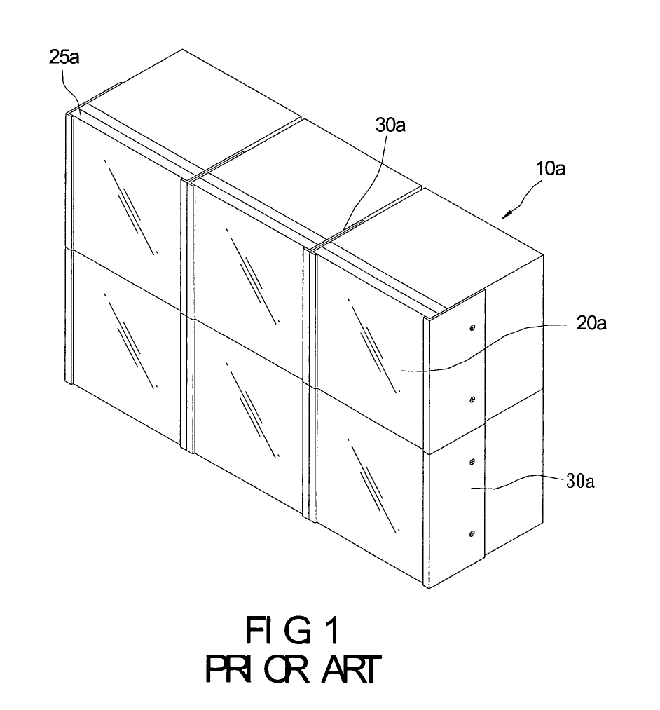

FIG. 2 is a perspective view of a single display unit in the prior art;

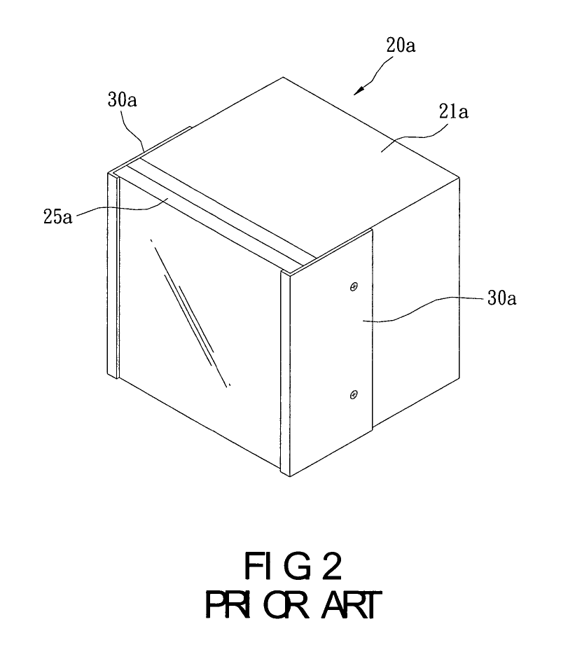

FIG. 3 is a perspective view of two adjacent display units in the prior art;

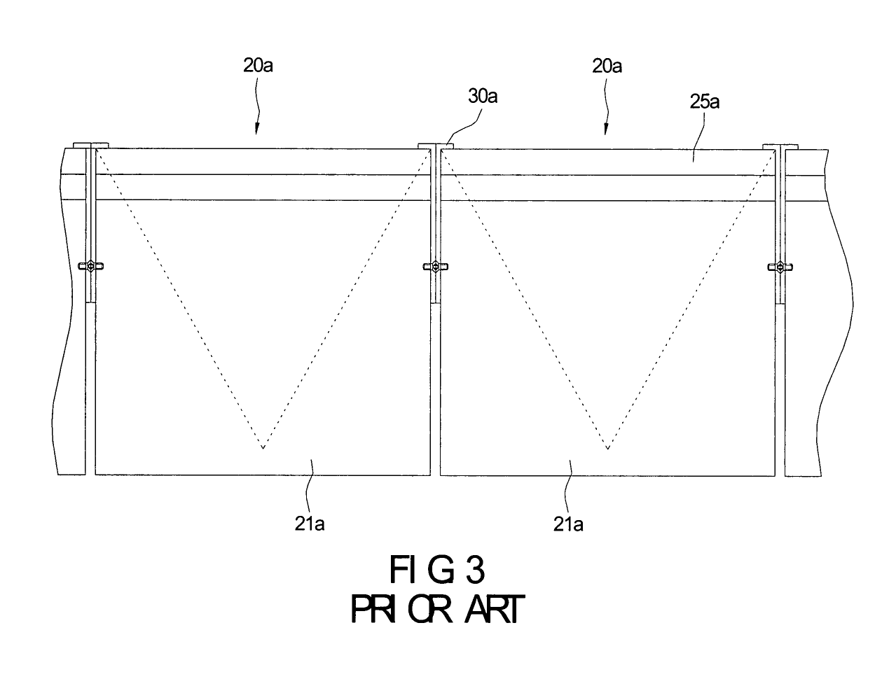

FIG. 4 illustrates the large-scale image with dark stripes in the prior art;

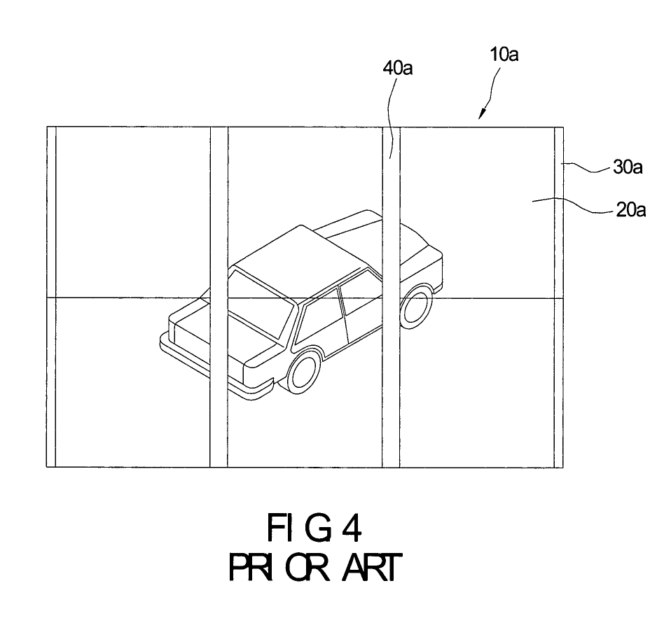

FIG. 5 is a perspective view of a large-scale display device according to a first embodiment of the invention;

FIG. 6 is a top view of two adjacent display units according to the first embodiment of this invention;

FIG. 7 is a top view of two adjacent display units according to a second embodiment of this invention; and

FIG. 8 is a perspective view of a large-scale display device according to the second embodiment of the invention.

### DETAILED DESCRIPTION OF THE PREFERRED EMBODIMENTS

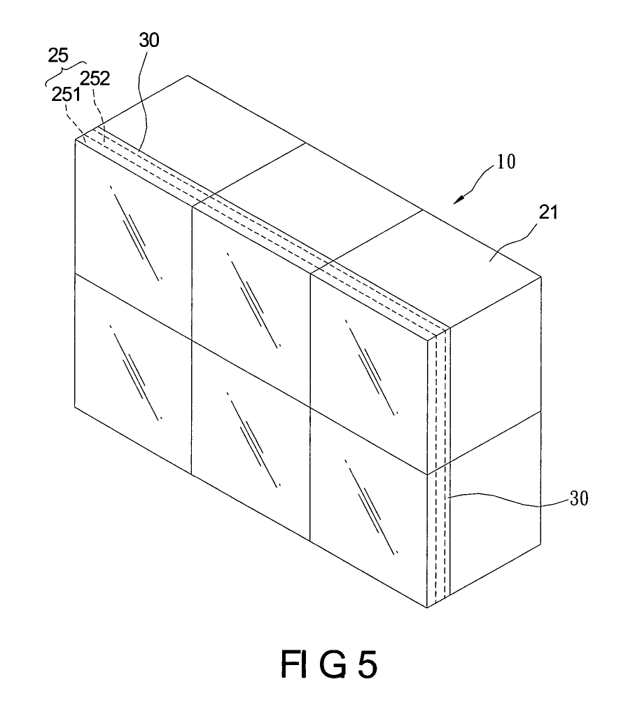

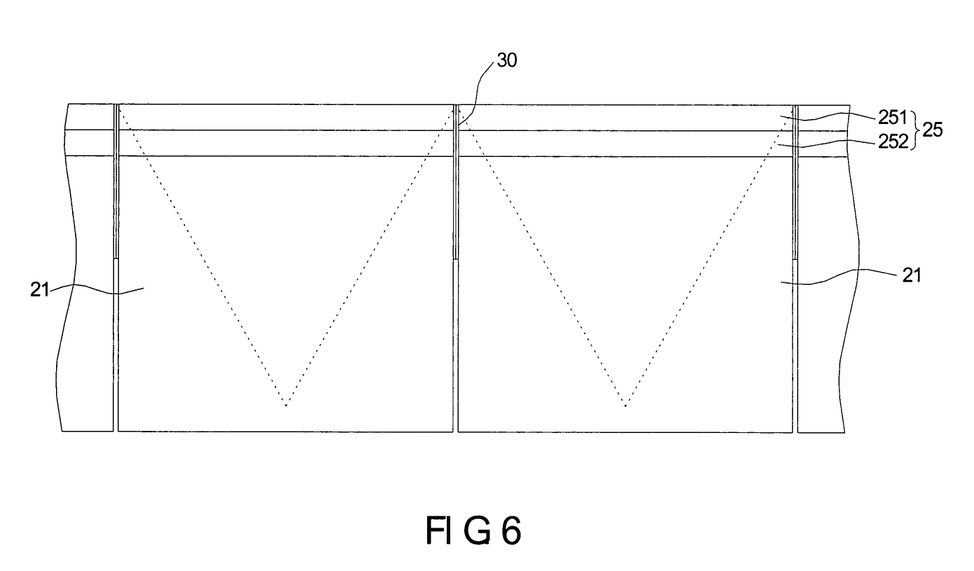

Referring to FIGS. 5 and 6, this invention is directed to a large-scale display device 10, comprising a plurality of display units 20, a plurality of screens 25 and a plurality of adhesive bands 30, in which the plurality of screen 25 is disposed on the display side of the plurality of display units 21, and the plurality of adhesive bands 30 are bonded on the side walls of the plurality of display units 21 and the plurality of screens 25, so as to individually keep the plurality of screens 25 attached to the plurality of display units 21.

In particular, the plurality of display units 21 is arranged in a matrix, and may be rear-projection TV units. The plurality of screen 25 comprises a diffuser 251 and a Fresnel optical lens 252 laminated in sequence. The plurality of screens 25 are disposed on the front display side of the plurality of display units 21 correspondingly, in such manner that the Fresnel lens 252 is disposed against the plurality of display units 21. Additionally, a plurality of adhesive bands 30 are affixed to the peripheral side walls of the plurality of display units 21 and the plurality of screens 25, so as to keep the plurality of screens 25 attached to the plurality of display units 21, in which the added thickness q of the two adjacent adhesive bands is less than 1.5 mm.

In this way, with reference to FIG. 6, since the added thickness q of two adhesive bands between two adjacent display units 21 is less than 1.5 mm and the adhesive bands are not affixed to the front surfaces of the screen 25, the light emitted through the display units from the projector (not shown) will not be blocked at the front side of the screens 25. The projected lights from two projectors (not shown) is controlled so as to intersect at two adjacent adhesive bands 30; thus, the dark stripes produced in the large-scale image by the adhesive bands between the plurality of display units 21 are greatly reduced in size and an enhanced aesthetic feeling of the large-scale image is presented.

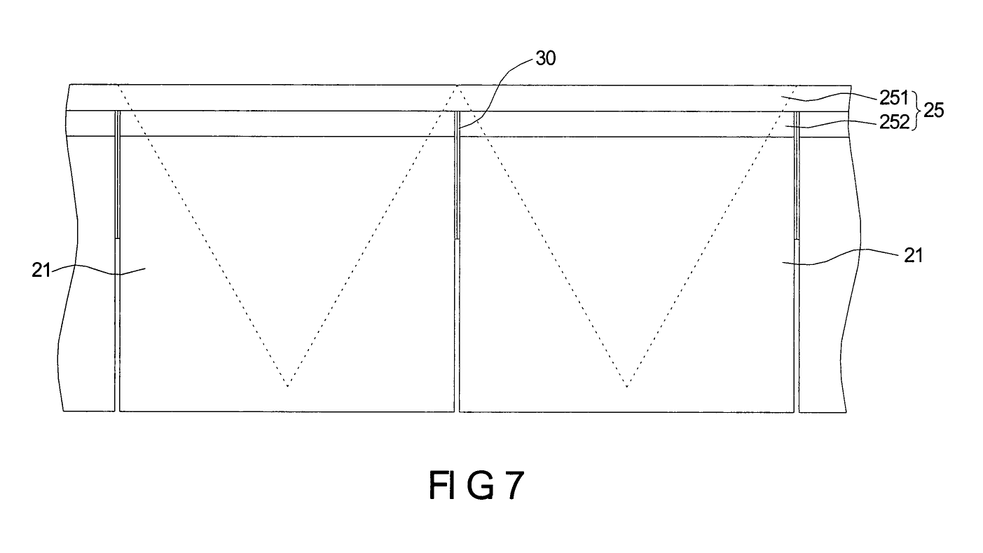

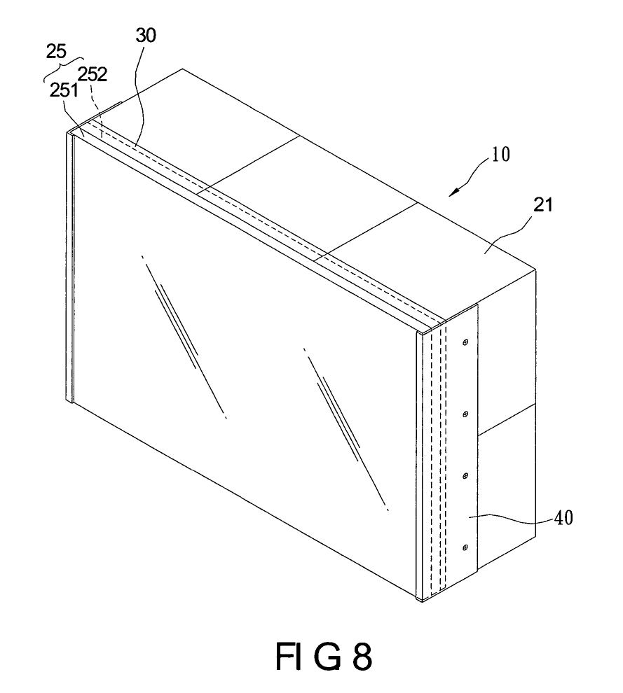

Referring to FIGS. 7 and 8, a plurality of Fresnel lenses 252 is further disposed on the front sides of the plurality of display units 21 by affixing the adhesive bands 30 to the peripheral sidewalls of the Fresnel lenses 252 and the display units 21. A single large-area diffuser 251 is further overlaid on the front sides of the plurality of Fresnel lenses 252, and a short side portion of the L-shaped fixing plate is used to retain the front rim of the diffuser 251 by pressing against the same. The long side portion of anther L-shaped fixing plate is fitted to the side rim of the display unit 21 in a locking manner, so as to fix the diffuser 251 to the display units 21. Therefore, when the lights from the projectors inside the display units 21 according to this invention are projected onto the Fresnel lenses 252, the dark stripes in the large-scale image can be reduced in size, and the lights are further enabled to penetrate through the single large-area diffuser 251, thus blurring the dark stripe and even achieving a large-scale image without any dark stripe, in order to enhance the aesthetic feeling of the large-scale image.

In conclusion, a large-scale display device according to this invention is arranged to affix a plurality of adhesive bands to both the plurality of screens and the display unit, so as to keep the plurality of screens attached to the display units, thus reducing the gaps between two adjacent displays and the dark stripe in the large-scale image.

Although possible embodiments of the invention have been described above, it is to be understood that the scope of the invention is not limited to these embodiments; in the same way, all equivalent structures and modifications as implemented in this specification and as illustrated in these drawings are covered within the scope of this invention, in order to protect the right of the inventor.

What is claimed is:

1. A large-scale display device comprising a plurality of display units arranged in array form and a plurality of screens disposed on a display side of the display units correspondingly, characterized by comprising a plurality of adhesive bands for affixing the screens to the display units, so as to keep the screens attached to the display units.

2. The large-scale display device according to claim 1, wherein each of the screens comprises a Fresnel lens and a diffuser disposed in a sequential laminating manner to keep attached to each of the display side of the display units by the adhesive bands.

3. The large-scale display device according to claim 1, wherein the display unit comprises rear-projection TV units.

4. The large-scale display device according to claim 1, wherein each adhesive band is affixed to each of the sidewalls of the display units and the screens.

5. The large-scale display device according to claim 1, wherein the adhesive bands are transparent adhesive bands.

6. The large-scale display device according to claim 1, wherein an added thickness of adjacent adhesive bands is less than about 1.5 mm.

7. The large-scale display device according to claim 1, wherein the screens comprises Fresnel lenses, the adhesive bands is affixed to the peripheral sidewalls of the Fresnel lens and the display units, and a plurality of fixing plates and a single diffuser are overlaid on a front side of the Fresnel lenses, and the diffuser is fixed to the display units by the fixing plates.

8. The large-scale display device according to claim 7, wherein the fixing plate is an L-shaped fixing plate, wherein one side portion thereof retains the front rim of the diffuser by pressing thereagainst and another side portion thereof is fixed to the display unit.
